(19) United States
(12) Patent Application Publication
(10) Pub. No.: US 2017/0001808 A1
(43) Pub. Date: Jan. 5, 2017

(54) Equipment Isolation System

(71) Applicant: Remsafe Pty Ltd, BALCATTA Western Australia (AU)

(72) Inventor: Michael Charles Lane, Dianella (AU)

(21) Appl. No.: 15/199,644

(22) Filed: Jun. 30, 2016

(30) Foreign Application Priority Data
Jun. 30, 2015 (AU) 2015902566

(51) Int. Cl. B65G 43/00; G05B 11/01

(52) U.S. Cl. CPC B65G 43/00; G05B 11/01

(57) ABSTRACT

An equipment isolation system (10) comprising at least one equipment item (20,25) including a shuttle conveyor system (25) including a conveyor shuttle (25A) energisable by an energy source (30) an automated conveyor shuttle locking system (250) operable for restricting conveyor shuttle (25A) movement during isolation and a control system (50,260) for automatically isolating said conveyor shuttle (25A) from said energy source to an isolated state in an isolation process wherein said control system (50,260) operates said automated shuttle conveyor locking system (250) as a step in said isolation process.

This invention relates to an equipment isolation system.

Various types of equipment must be isolated from a range of energy sources including electrical energy (the most common) and mechanical energy including pressure and potential energy to enable safe maintenance and other work to be carried out. Conveyor belt systems used in the mining industry for transporting iron ore or other bulk materials which can span significant distances are one such example of equipment which may require to be isolated from time to time.

The distances such conveyor belt systems can span can be in the range of many kilometres. Such conveyors are typically powered by electric drive motors: three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include corresponding brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems or components that—if energised—could cause a safety hazard. It will however be understood that equipment items other than conveyor systems and other mining industry equipment also require isolation for maintenance and other purposes.

The isolation process is invariably safety critical and has, in the past, been time consuming, as described for example in the introduction to the Applicant's granted Australian Patent No. 2010310881 and International Publication No. WO 2012/142674, the contents of which are incorporated herein by way of reference.

The remote isolation system described in Australian Patent No. 2010310881 enables equipment isolation to be requested at a remote isolation station associated with the equipment and subsequently approved through a plant control system, without mandatory visitation to the equipment by authorised isolation personnel. This remote isolation system significantly reduces the time required to achieve safe isolation, and more specifically the production downtime that would normally be involved with such an isolation which can be very costly.

Whilst the Applicant's remote isolation system is very efficient and attractive to mining companies seeking to minimise the downtime of their plant critical equipment, certain applications may warrant further safety assurance being provided in respect of any isolations to be effected. This is partly due to the fact that, for a range of reasons, equipment may revert or be switched from an isolated state to an energised state when such a change in state is not desired and which in turn may result in one or more safety hazards. For example, equipment may accidentally be re-energised even though work on that equipment is intended or currently taking place.

A particular problem concerns isolation of shuttles on conveyors especially, but not exclusively, for shuttle brake maintenance and work done within the shuttle structure and its surrounds. A conveyor with a shuttle facility typically includes an inclined conveyor extending to significant elevation with a shuttle at the head end. The shuttle moves an end or delivery tip of the conveyor back and forth, shuttling it into position over a required chute or a plurality of chutes for feeding respective downstream conveyors as required. A shuttle conveyor system includes a braking system for controlling movement of the shuttle between its respective positions.

The Applicant has found that practice in isolating conveyor shuttle systems is inconsistent, which is surprising given the evident hazard caused by the stored potential energy due to the elevation and mass of the shuttle. Sometimes maintenance proceeds without isolation of the braking system (which does not always engage, allowing some metres of potentially hazardous shuttle movement) though more usually shuttle locking pins are manually installed to allow such maintenance on an irregular basis. Shuttle locking pin installation is highly inconvenient and typically includes problems of poor access; disassembly, in a limited space, of safety guards to minimise risk of operator contact with conveyor shuttle components; and transport of locking pins to the required elevated location, both operations taking time and involving their own safety issues, It follows that preventative maintenance may not occur at the most desirable frequency and may take significant time. Prior isolation methods also lack an evident isolation point for lockout.

It is therefore an object of the present invention to provide a safer and more efficient isolation system for isolating conveyor shuttle systems.

With this object in view, the present invention provides an equipment isolation system comprising:

at least one equipment item including a shuttle conveyor system including a conveyor shuttle energisable by an energy source;

an automated conveyor shuttle locking system operable for restricting conveyor shuttle movement during isolation; and

a control system for automatically isolating said conveyor shuttle from said energy source to an isolated state in an isolation process wherein said control system operates said automated shuttle conveyor locking system as a step in said isolation process.

The automated conveyor shuttle locking system comprises means to lock the shuttle in a determined position for maintenance. The locking means may comprise pins or wedges operable into and out of complementary locking means, such as recesses, through a drive system such as an electric motor. The drive system may operate the locking means between an isolated state and a normal operating state by movement of a hydraulic ram or spudlock.

The isolation system advantageously provides an accessible isolation lockout point for the conveyor shuttle locking system. In addition, the equipment isolation system advantageously avoids interference with safety guards provided for the conveyor shuttle system during isolation processes. By interference is meant inconvenient requirement for disassembly and re-assembly of the safety guards to conduct isolation and de-isolation.

The equipment isolation system may enable continuous monitoring of the position of the conveyor and shuttle both prior to and during an isolation. Such monitoring has an object of ensuring integrity of the conveyor shuttle isolation.

Continuous monitoring may include use of securing means, including sensors such as position sensors preferably comprising a plurality of sensors, as described in the Applicant's Australian Provisional Patent Application No. 2015902556, the contents of which are incorporated herein by way of reference.

The shuttle conveyor system is likely to be associated with further equipment which may also be isolated by the control system. Such further equipment may include a conveyor belt system for conveying the same material as conveyed by the shuttle conveyor system. For example, the conveyor belt system may feed the shuttle conveyor system.

The equipment isolation system may advantageously, but not exclusively, be configured and operated in accordance with the Applicant's remote isolation systems which approve isolation on permissible request logged by an operator at a remote isolation station. Such systems and components are described, for example, in Australian Patent No. 2010310881 and the Applicant's Australian Provisional Patent Application Nos. 2015902554, 2015902556, 2015902557, 2015902558, 2015902559, 2015902561, 2015902562, 2015902564 and 2015902565 each filed on 30 Jun. 2015, the contents of which are incorporated herein by way of reference, and which comprehend both fixed and mobile isolation stations. Such equipment isolation systems would provide an isolation lockout switch and lockout point at each remote isolation station corresponding with the shuttle conveyor system.

Shuttle conveyor systems, and other equipment for that matter, may often include access means which prevent operator access when the equipment is operating. Such access means may, for example, include a gate or door which is locked when the equipment is operating. A remote isolation station could be configured to release, for example through operation of an electronic or electro-mechanical device, a secondary key, such as a gate key, when isolation is complete allowing an operator to open the access means to enable equipment maintenance.

The above described embodiment relates to isolation of shuttle conveyors, but other equipment may also include controllable locking systems to prevent equipment component motion. A further embodiment therefore provides an equipment isolation system comprising:

at least one equipment item including a movable component energisable by an energy source;

an automated locking system, particularly a locking system including automated locking pins or like elements, operable for restricting movement of said movable component during isolation; and

a control system for automatically isolating said equipment from said energy source to an isolated state in an isolation process wherein said control system operates said movable component locking system as a step in said isolation process.

Such equipment items with movable components may include, for example but without limitation, equipment used in the mining, materials handling and chemical industries, Scrubbers and drums, for example, are movable components which may require to be locked into position for maintenance purposes.

The equipment isolation systems, as described here, may be retro-fitted into existing plants and are also suitable for ‘greenfield’ plants in a range of industries including the mining, materials handling and chemical industries.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g.

potential energy), from the equipment. For example, such an additional energy dissipation step could be effected in respect of a conveyor belt system by way of the braking cycle procedure as described in the Applicant's Australian Provisional Patent Application No. 2015902565, the contents of which are incorporated herein by way of reference.

The equipment isolation system may be more fully understood from the following description of a preferred embodiment thereof made with reference to the following drawings in which:

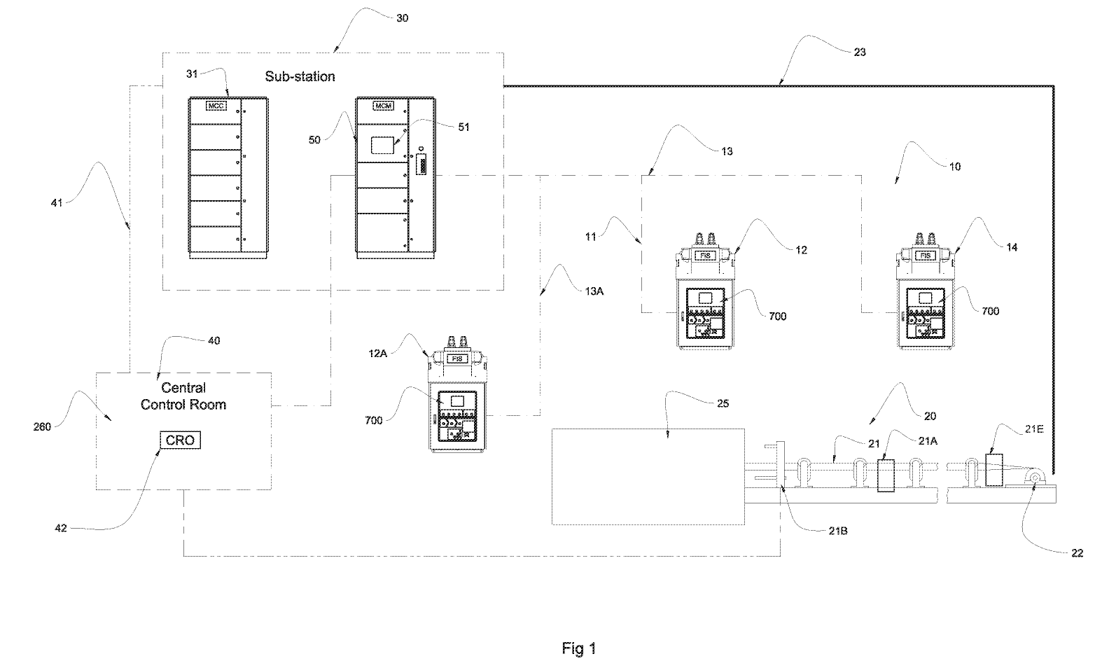

FIG. 1 shows a schematic layout of an equipment isolation system as applied to a conveyor belt system including a shuttle conveyor system in accordance with a preferred embodiment.

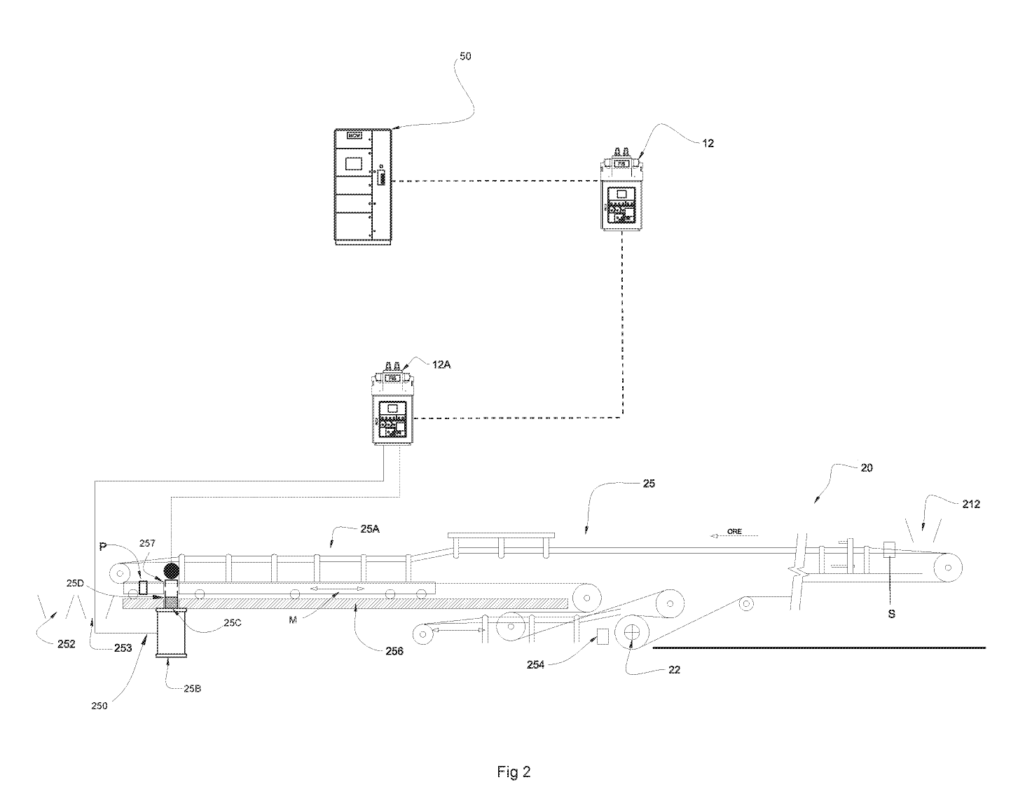

FIG. 2 shows a detailed schematic view of the shuttle conveyor system of FIG. 1.

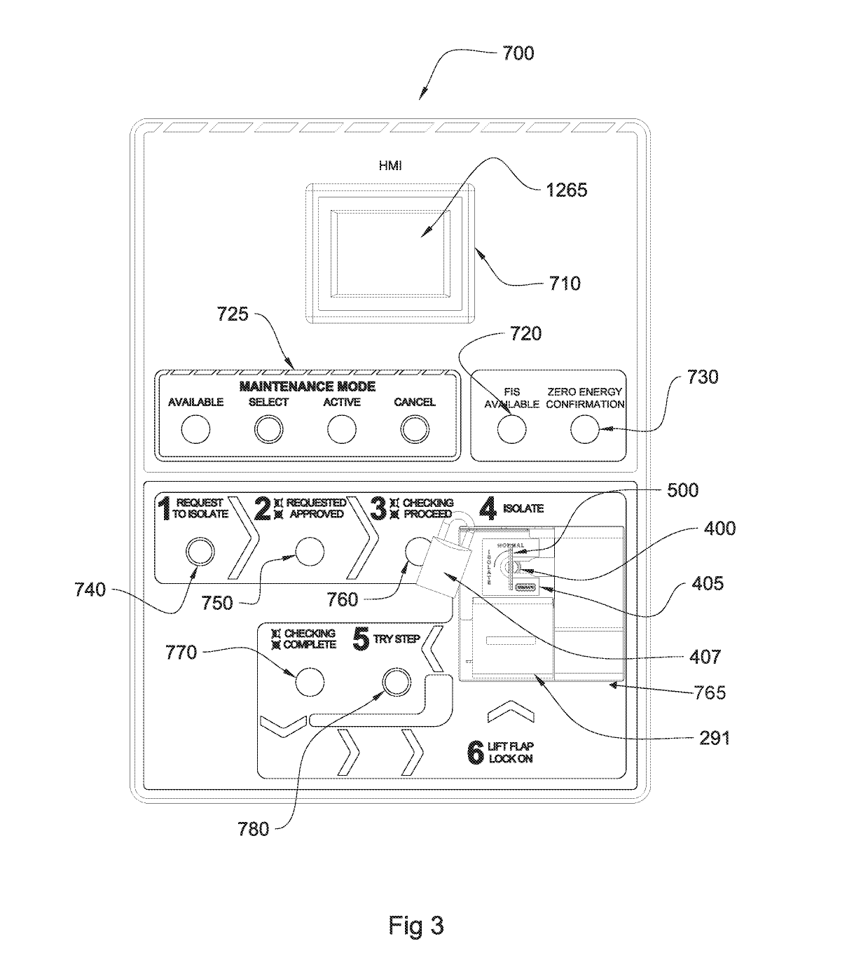

FIG. 3 shows a control panel provided inside the remote isolation station of FIG. 2 with the shuttle conveyor belt system in normal position.

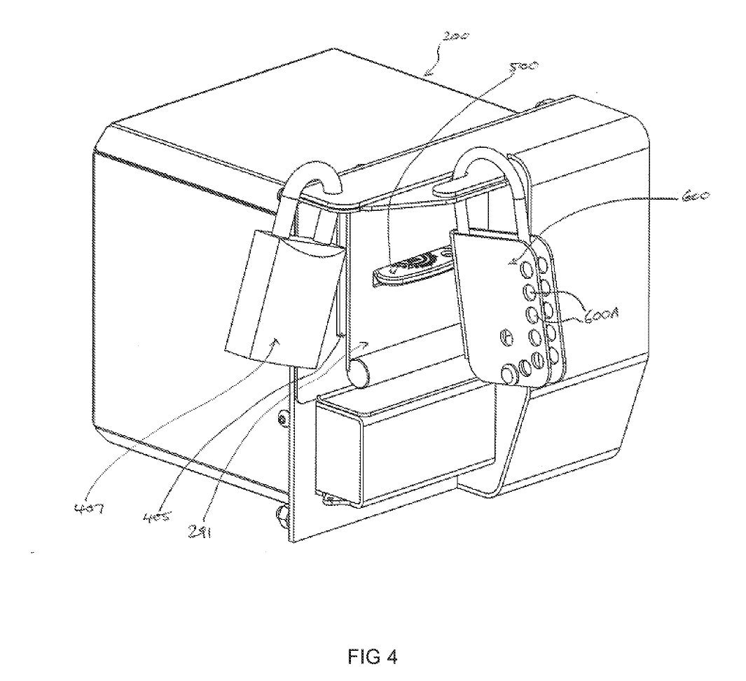

FIG. 4 shows an isolation lockout switch box used in the control panel of FIG. 3 and showing the isolation lockout switch in isolation lockout condition.

Referring to FIG. 1, there is shown a schematic layout of a remote isolation system 10, as retrofitted to an existing conveyor belt system 20, for example a long overland conveyor system for conveying iron ore from a mine site to a port for shipment. The conveyor belt system 20 comprises a troughed conveyor belt 21 feeding a shuttle conveyor system 25 as described further below with reference to FIG. 2. The conveyor belt system 20 also includes a Tramp Metal Detector (TMD) 21B and conveyor brake 21E which is activated to bring the conveyor belt 21 to a stop.

The conveyor belt 21 has a head pulley motor 22 driven by an electrical supply emanating from electrical contacts 31, whether provided as contactors or circuit breakers. One contact is a standard contactor for “ON”/“OFF” operation of the motor 22. The head pulley motor 22 is powered through a Variable Speed Drive (VSD) which is electrically powered from a 3 phase AC power supply line 23 providing voltages of less than 1000V AC. The electrical power is supplied from a sub-station 30. The sub-station 30 houses the contacts 31. Activation of the contacts 31 (i.e. placing them in the “off” or “break” state), de-energises all 3 phases of the electrical supply to the conveyor head pulley drive motor 22. Such de-energisation is continuously monitored by a voltage monitor relay (not shown) located downstream of contacts 31, i.e. on the conveyor belt system 20 side of the contacts 31.

Shuttle conveyor system 25, as shown in more detail in FIG. 2, includes an inclined conveyor 25 with a shuttle 25A at the head end of conveyor 25 supported by structural members 256. Stored potential energy due to the elevation and mass of shuttle 25A which could cause hazard is apparent from FIG. 2 and the isolation system is intended to mitigate against this hazard. Shuttle conveyor 25 also includes safety guards (not shown) to minimise risk of operator contact with conveyor components. Shuttle conveyor 25 is fed with iron ore from conveyor belt 21 through chute 212. Shuttle 25A moves an end or delivery tip of the conveyor 25 back and forth in directions M, shuttling it into position over chutes 252 and 253 feeding respective downstream conveyors (not shown) as required. Shuttle conveyor system 25, together with its braking system 254, is driven by the power supply from sub-station 30 and emanating through electrical contacts in an analogous conventional manner to conveyor belt system 20.

The conveyor belt system 20, shuttle conveyor system 25 and sub-station 30 are under the control and supervision of a plant control system 260 having a Central Control Room (CCR) 40, via a Distributed Control System (DCS), Programmable Logic Controller (PLC) and Supervisory Control and Data Acquisition System (SCADA) as are commonly used within the industry and would be well understood by the skilled person. Item 41 in FIG. 1 is representative of a communication and control network between the CCR 40 and the various other plant and isolation systems and components, A Control Room Operator (CRO) 42 is located within the CCR 40 and has various Input/Output (I/O) devices and displays available for the proper supervision and control of the conveyor belt system 20.

The conveyor belt system 20 and shuttle conveyor system 25 are isolated by a remote isolation system operable as described in Australian Patent No. 2010310881, the contents of which are incorporated herein by way of reference. The same control system including master controller 50 controls isolation of both the conveyor belt system 20 and shuttle conveyor 25 when required.

The isolation system for the shuttle conveyor system 25 specifically includes fixed remote isolation station 12A (as opposed to fixed remote isolation stations 12 and 14 which are used essentially in isolation of conveyor belt system 20). Remote isolation station 12A, which is located proximate to the shuttle conveyor system 25, includes a control panel 700 for use in the isolation process (as will be subsequently described with reference to FIG. 3), which may advantageously be configured and operated as described in Australian Patent No. 2010310881 and the Applicant's Australian Provisional Patent Applications each filed on 30 Jun. 2015 (including Provisional Patent Application No. 2015902554), the contents of which are incorporated herein by way of reference.

It will be understood that remote isolation station 12A could be replaced or supplemented by one or more mobile isolation stations, for example in the form of portable computer devices (in certain applications these potentially being provided as smartphones) or communication devices using wireless communications, as disclosed for example in the Applicant's Provisional Patent Application Nos. 2015902561 and 2015902562 the contents of which are herein incorporated by way of reference. The remote isolation station 12A may be powered from the plant grid, other power networks or alternative power sources, conveniently such as via solar power.

The remote isolation system 10 also includes a master controller 50 incorporating a Human/Machine Interface (HMI) in the form of a touch sensitive screen 51 which displays human interpretable information. The master controller 50 is also located within sub-station 30. Remote isolation station 12A communicates with the master controller 50 through communication channel 13A. Remote isolation stations 12 and 14 communicate with master controller 50 and each other via communication channels such as channels 11 and 13. These communication channels can be provided in any suitable form including hard wired or wireless forms that satisfy known industrial open communication protocols with Ethernet communications being particularly preferred to enable flexible system updating. Communications must be via safety rated communications protocol software, noting that these may be varied depending on the PLC platform used. For example, the Interbus Safety or PROFIsafe software solutions provide an indication of existing systems which are well known within the mining and materials handling industries. This will ensure that the communication channels are monitored and diagnostic tools are available for fault control and rectification when required.

Further description of the electrical layout and operation of the remote isolation system is provided in the Applicant's granted Australian Patent No. 2010310881, the contents of which are incorporated herein by way of reference. Advantageously, the remote isolation system 10 includes securing means for continuously monitoring and maintaining isolation integrity as described in the Applicant's Australian Provisional Patent Application No. 2015902556, the contents of which are also incorporated herein by way of reference.

In summary, when required, the shuttle conveyor system 25 is isolated by a process involving:
An operator request at remote isolation station 12A for the control system to approve isolation of shuttle conveyor system 25;
Isolation being approved if the operator request meets permissives for isolation, for example as described in the Applicant's Australian Patent No. 2010310881;
A try step process, as best seen with reference to FIG. 3, being invoked to check that the isolation is effective, which involves checking that electrical contacts for the shuttle conveyor system 25 are in isolated position with no voltage being detected by a voltage monitor relay downstream of the electrical contacts 31 (with no voltage being indicated in a ‘zero energy confirmation’ at the control panel 700); an attempt to re-start the shuttle conveyor system 25 using try step button 780 or an automated process; and checking that there is no re-energisation of shuttle conveyor 25 (for example as monitored by shuttle conveyor 25 movement as sensed by a speed monitor and/or proximity sensor S as shown in FIG. 2 both prior to and during isolation); and
Lockout at the control panel of remote isolation station 12A, with an isolation lockout switch if the try step process is unsuccessful (as required).

FIG. 3 shows a schematic of the control panel 700 located within the remote isolation station 12A. Panel 700 has a Human Machine Interface (HMI) 710 with a touch screen 1265 (though less fragile buttons, switches and other input devices may be used in alternative arrangements) for entering commands including issuing isolation requests to the plant control system 260). A request button 740 is provided for isolation requests. Information can also be presented on screen 1265 in respect of any such isolation requests including isolation status and other plant data Control panel 700 also includes;
indicator light 720 showing whether or not the remote isolation station 12A is available for isolation;
indicator light block 725 showing whether or not bypass or maintenance mode for the remote isolation system is active as described in Australian Provisional Patent Application No. 2015902557, the contents of which are incorporated herein by way of reference; and respective “select” and “cancel” buttons for initiating or terminating the maintenance mode;
indicator light 730 for indicating zero energy confirmation when sensors, such as the load voltage monitor relay described above and shuttle conveyor movement sensors P and S, indicate zero hazardous energy in the conveyor belt system 20 and shuttle conveyor system 25;
request isolation button 740 which is activated by an operator (and which illuminates when pressed) to request isolation and “request approved” indicator light 750 which illuminates to provide status information to said operator;
indicator light 760 for showing correctness of selection of the shuttle conveyor system 25 for isolation and for indicating that control system checking is taking place subsequent to an isolation request being instigated;
indicator light 770 for showing whether or not the isolation process is complete following control system checking;
try step button 780 for requesting a try start of shuttle conveyor system 25 as described above; and
isolation switch block 765 including lockout switch 400 (shown with key 500 in a normal position with keeper plate 405 locked by padlock 407 to prevent removal of key 500 from the isolation lockout switch 400. Isolation lockout is further evident with reference to FIG. 4 showing the isolation switch box 200 detached from control panel 700. Lockout switch 400 has key 500 in isolated position with flap lock member 291 in correct position for application of hasp 600 securely and correctly accommodated for isolation lockout. Multiple operators may need to lockout applying their own hasps to hasp 600 using apertures 600A).

Further description of the construction and operation of a suitable lockout switch is provided in the Applicant's Australian Provisional Patent Application No. 2015902554, the contents of which are incorporated herein by way of reference.

Remote isolation system 10 provides additional security to those working on shuttle conveyor system 25. When isolated, braking system 254 as shown in FIG. 2 for shuttle conveyor 25 is engaged (i.e. the brake is ON when the power to the brake is OFF) and excessive reliance could be placed on that brake to hold the shuttle 25A in correct position for isolation over chute 252. This might be acceptable for minor tasks not requiring work on the shuttle 25A itself. However, the shuttle conveyor 25 is more desirably locked into isolation position as a step in the isolation process summarised above. This would be essential where maintenance of braking system 254 is required.

To this end, the shuttle conveyor system 25 includes an automated locking pin system 250 for locking it into isolation position. The automated locking pin system 250, as schematically shown in the detail of FIG. 2, comprises an electrically driven hydraulic ram 25B including a locking pin 25C which can be driven through stop members 25D in and out of engagement with the corresponding recess 257 when locking (to prevent shuttle 25A movement) is required. Although only one locking pin system 250 has been shown in FIG. 2, it will be understood that further locking pin systems may be installed if required. The locking pins are robust and capable of bearing the weight of the shuttle 25A without failure.

A belt clamp system having automated clamps 21A, analogous to that described in the Applicant's Australian Provisional Patent Application No. 2015902565, the contents of which are incorporated herein by way of reference, may also be used to prevent movement of conveyor belt 21.

Accordingly, following successful passing of the try step of the isolation process, control system 260 actuates hydraulic ram 25B to drive a locking pin 25C between stop members 25D into a complementary recess 257. At this point, shuttle 25A is in the required isolation position.

Plant control system 260 (or master controller 50) also commands hydraulic ram 25B to retract locking pin 25C from its locked position in recess 257 when shuttle conveyor 25 is ready for return to service following maintenance.

The locked position of shuttle 25A is monitored by a suitable proximity sensor P and reported to plant control system 260 and displayed on screen 1265 along with isolation status and shuttle locking pin 25C engagement status. An interlock with the conveyor shuttle drive motor also prevents operation of the drive motor when locking pin 25C is monitored as in locked position. Movement sensor S, which could be provided with or as a belt standstill monitor (BSM) as described in the Applicant's Australian Provisional Patent Application Nos. 2015902556 and 2015902565, and proximity sensor P also operate continuously during isolation to monitor isolation integrity and enable warning against shuttle conveyor 25 movement. Sensors S and P send signals to the master controller 50 (safety PLC).

Use of an automated, rather than a manually installed, shuttle locking pin system 250 saves considerable time on shuttle maintenance and is also safer. For example, safety is enhanced through improved accessibility because there is no need for the conveyor safety guards to be removed for the isolation process, only for maintenance. An accessible isolation lockout point is also provided, in contrast to prior practice, at the shuttle conveyor 25 lockout switch located at remote isolation station 12A.

Further, considerable time savings can be achieved by integrating the operation of the automated locking pin system 250 with operation of the remote isolation system 10 as above described. The shuttle locking pins 25C do not require manual, or even automatic, installation in separate steps after isolation lockout and this saves time for production. Actuation of the locking pin system 250 is controlled as part of an isolation event, with confirmation of engagement of locking pins 250 enabling the isolation event to take place.

Modifications and variations to the equipment isolation system of the present invention will be apparent to the skilled reader of this specification. Such modifications and variations are deemed within the scope of the present invention. For example, in another embodiment, the equipment isolation system may also be applied to isolation of movable components by automated locking systems in equipment other than shuttle conveyor systems 25. Such movable components may include scrubbers or drums in mining equipment which require to be locked into a determined position for maintenance.

Furthermore, while the control panel 700 has primarily been described as including a Human Machine Interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. An equipment isolation system comprising:
at least one equipment item including a shuttle conveyor system including a conveyor shuttle energisable by an energy source;
an automated conveyor shuttle locking system operable for restricting shuttle movement during isolation; and
a control system for automatically isolating said shuttle from said energy source to an isolated state in an isolation process wherein said control system operates said automated shuttle locking system as a step in said isolation process.

2. An equipment isolation system as claimed in claim 1 wherein said automated conveyor shuttle locking system comprises means to lock the shuttle in a determined position, said locking means comprising pins or wedges operable into and out of complementary locking means through a drive system.

3. An equipment isolation system as claimed in claim 2 wherein said drive system operates the locking means between an isolated state and a normal operating state by movement of a hydraulic ram or spudlock.

4. An equipment isolation system as claimed in claim 1 including securing means for continuous monitoring of the position of the conveyor and shuttle both prior to and during an isolation.

5. An equipment isolation system as claimed in claim 4 wherein said securing means includes at least one sensor such as a position sensor.

6. An equipment isolation system as claimed in claim 1 wherein said shuttle conveyor system is associated with further equipment which may also be isolated by said control system.

7. An equipment isolation system as claimed in claim 6 wherein said further equipment is a conveyor belt system for conveying the same material as conveyed by the shuttle conveyor system.

8. An equipment isolation system as claimed in claim 1 wherein isolation of a conveyor belt includes operation of an automated belt clamp arrangement by said control system.

9. An equipment isolation system comprising:
at least one equipment item including a movable component energisable by an energy source;
an automated locking system operable for restricting movement of said movable component during isolation; and
a control system for automatically isolating said equipment from said energy source to an isolated state in an isolation process wherein said control system operates said movable component locking system as a step in said isolation process.

10. An equipment isolation system as claimed in claim 9 wherein said automated locking system includes automated locking means comprising pins or wedges operable into and out of complementary locking means through a drive system.

11. An equipment isolation system as claimed in claim 9 wherein said equipment item includes a movable scrubber or drum which requires to be locked into position for maintenance purposes.

12. An equipment isolation system as claimed in claim 9 being a remote isolation system wherein said equipment is automatically isolated on permissible request by an operator logged at a remote isolation station.

13. An equipment isolation system as claimed in claim 12 wherein said remote isolation station is a mobile isolation station.

14. An equipment isolation system as claimed in claim 12 wherein said equipment includes an access means which prevents operator access when the equipment is operating and a remote isolation station is configured to release a secondary key when isolation is complete allowing an operator to open the access means to enable equipment maintenance.

15. An equipment isolation system as claimed in claim 1 wherein an accessible isolation lockout point is provided.
